(19) United States
(12) Patent Application Publication
(10) Pub. No.: US 2024/0327098 A1
(43) Pub. Date: Oct. 3, 2024

(54) DOUBLE-WALLED RESIN CONTAINER AND METHOD FOR PRODUCING SAME

(71) Applicant: NISSEI ASB MACHINE CO., LTD., Nagano (JP)

(72) Inventors: Michihito ITO, Nagano (JP); Manabu OGIHARA, Nagano (JP); Atsushi NAGASAKI, Nagano (JP); Masayuki USAMI, Nagano (JP)

(73) Assignee: NISSEI ASB MACHINE CO., LTD., Nagano (JP)

(21) Appl. No.: 18/286,868

(22) PCT Filed: Apr. 14, 2022
(86) PCT No.: PCT/JP2022/017765

§ 371 Date: Apr. 30, 2024

(30) Foreign Application Priority Data
Apr. 16, 2021 (JP) 2021-069673

(51) Int. Cl. B65D 81/38; B29C 49/12; B29L 31/00; B65D 77/04

(52) U.S. Cl. CPC B65D 81/3869; B65D 77/0493; B29C 49/12; B29L 2031/7132

(57) ABSTRACT

A double-walled resin container includes: an outer container made of resin and having a tapered shape in which an upper surface is opened, a bottom surface is closed, and a diameter is reduced from an upper surface side to a bottom surface side; and an inner container made of resin and inserted into the outer container from the upper surface side, the double-walled resin container including a heat insulating space in a gap between the outer container and the inner container. The outer container and the inner container are each formed by a biaxial stretch blow method.

### BACKGROUND OF THE INVENTION

### Field of the Invention

The present invention relates to a double-walled resin container and a manufacturing method.

### Description of the Related Art

Conventionally, a double-walled container configured by fitting an outer container and an inner container is known as one of resin containers (for example, JP 2019-077457 A, JP 2019-077458 A and JP 2019-119516 A). In this type of double-walled resin container, an air layer between the outer container and the inner container functions as a heat insulating material, and the heat retention time or the cold retention time of the content can be extended. In addition, when the content is at a low temperature, dew condensation can be suppressed from occurring on the outer container, and even when the content is at a high temperature, there is no problem in holding the container in hand.

Currently, the double-walled resin container is mainly manufactured by a sheet molding method (vacuum molding method, pressure molding method, and press molding method). However, by the sheet molding method, a cup-shaped container having a deep bottom is likely to deteriorate in appearance of the container and physical properties of the container, and it is very difficult to form the cup-shaped container. Moreover, in the case of the sheet molding method, there is also room for improvement in that an operation of trimming the container from the sheet is required.

### SUMMARY OF THE INVENTION

A double-walled resin container according to an aspect of the present invention includes: an outer container made of resin and having a tapered shape in which an upper surface is opened, a bottom surface is closed, and a diameter is reduced from an upper surface side to a bottom surface side; and an inner container made of resin and inserted into the outer container from the upper surface side, the double-walled resin container including a heat insulating space in a gap between the outer container and the inner container. The outer container and the inner container are each formed by a biaxial stretch blow method.

Further features of the present invention will become apparent from the following description of exemplary embodiments with reference to the attached drawings.

### BRIEF DESCRIPTION OF THE DRAWINGS

FIG. 1A is a front view of a double-walled container of the present embodiment, and FIG. 1B is a cross-sectional view taken along line A-A of FIG. 1A.

FIG. 2A is a front view of an outer container, and FIG. 2B is a front view of an inner container.

FIG. 3A is an enlarged view of an upper end portion of an outer container, and FIG. 3B is an enlarged view of an upper end portion of an inner container.

FIG. 4A is a partial cross-sectional view of the vicinity of an upper end of a double-walled container, and FIG. 4B is a partial cross-sectional view of the vicinity of a bottom portion of the double-walled container.

FIG. 5A is a front view illustrating a stacked state of the double-walled containers of the present embodiment, FIG. 5B is a partial cross-sectional view of the vicinity of upper ends of the double-walled containers in the stacked state, and FIG. 5C is a partial cross-sectional view of the vicinity of bottom portions of the double-walled containers in the stacked state.

FIG. 6 is a view illustrating a manufacturing step of the double-walled container of the present embodiment.

FIG. 7 is a view illustrating a configuration example of a blow molding apparatus applied to the manufacture of the container of the present embodiment.

### DESCRIPTION OF THE EMBODIMENTS

Hereinafter, an embodiment of the present invention will be described with reference to the drawings.

In the embodiment, for the sake of easy description, structures and elements other than a main part of the present invention will be described in a simplified or omitted manner. In addition, in the drawings, the same elements are denoted by the same reference numerals. Note that the shapes, dimensions, and the like of the elements illustrated in the drawings are schematically illustrated, and do not indicate actual shapes, dimensions, and the like.

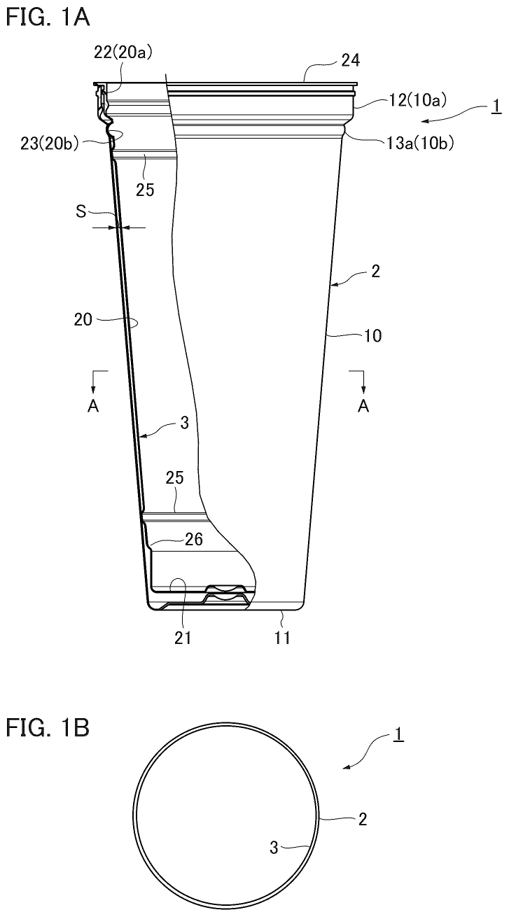

FIG. 1A is a front view of a double-walled container 1 of the present embodiment, and FIG. 1B is a cross-sectional view taken along line A-A of FIG. 1A. As illustrated in FIG. 1A, the double-walled container 1 is a wide-mouth cup-shaped container having a tapered shape in which an upper surface is opened and a bottom surface is closed, and the diameter is reduced from the upper surface side to the bottom surface side (inverted truncated cone shape). In addition, the double-walled container 1 has a length (depth) in the axial direction of the container sufficiently longer than the inner diameter and the outer diameter of the container, and is formed to have a deep bottom. The double-walled container 1 (inner container 3 to be described below) is formed to be able to contain, for example, 350 ml to 900 ml of the content (liquid).

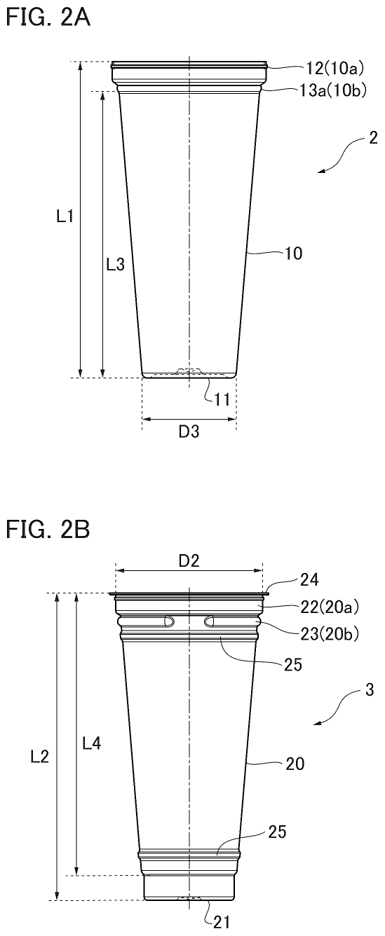

In addition, the double-walled container 1 includes an outer container 2 and the inner container 3. FIG. 2A is a front view of the outer container 2, and FIG. 2B is a front view of the inner container 3.

The outer container 2 is a container exposed to the outside of the double-walled container 1, and the overall shape thereof is substantially the same as the overall shape of the double-walled container 1 described above. The outer container 2 has an opening 10a, a coupling portion 10b, a body portion 10, and a bottom portion 11 that closes the lower side of the body portion 10.

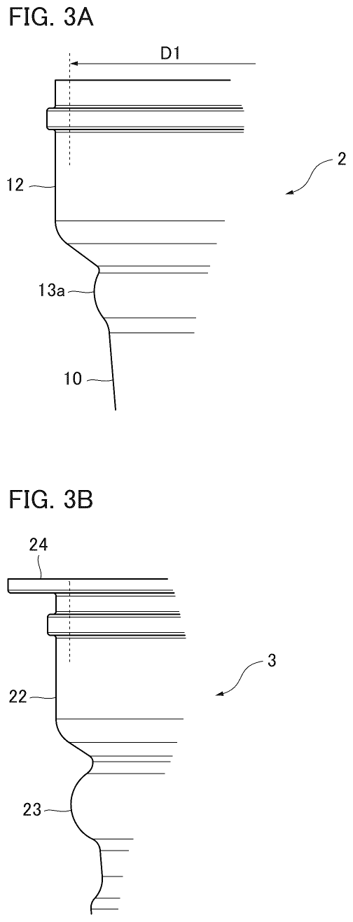

FIG. 3A is an enlarged view of an upper end portion of the outer container 2. A stepped portion 12 having an annular shape constituting a largest outer diameter portion of the outer container 2 is formed on an upper end side (opening 10a) of the outer container 2. In addition, the coupling portion 10b is formed on the lower side (between the opening 10a and the body portion 10) of the stepped portion 12, and an engagement groove 13 is formed on the inner circumference of the outer container 2 at the coupling portion 10b. The stepped portion 12 and the engagement groove 13 are formed in parallel adjacent to each other in the axial direction of the outer container 2.

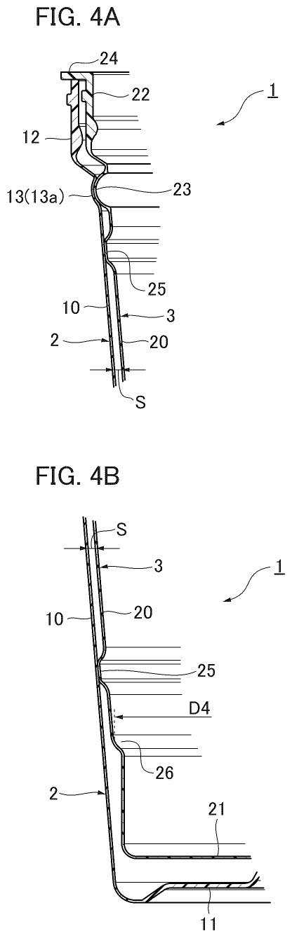

The engagement groove 13 is formed in an annular shape along the circumferential direction of the outer container 2, and as illustrated in FIG. 4A to be described below, an axial cross-section of the engagement groove 13 has an arc shape. In addition, the engagement groove 13 when viewed from the outer peripheral side of the outer container 2 appears as an annular protrusion 13a having an arc shape in the axial direction and protruding to the outer peripheral side.

The material of the outer container 2 is thermoplastic synthetic resin, and can be appropriately selected depending on the specifications of the outer container 2. Specific examples of the material type include polyethylene terephthalate (PET), polyethylene naphthalate (PEN), polycyclohexanedimethylene terephthalate (PCTA), Tritan ((registered trademark): copolyester manufactured by Eastman Chemical Company), polypropylene (PP), polyethylene (PE), polycarbonate (PC), polyethersulfone (PES), polyphenylsulfone (PPSU), polystyrene (PS), cyclic olefin polymer (COP/COC), polymethyl methacrylate: acrylic (PMMA), polylactic acid (PLA), and the like. Since the outer container 2 is exposed to the outside of the double-walled container 1, and physical properties and appearance are important, it is preferable to apply, as an example, PET, which is a material having a large strain hardening property, good formability, and translucency (transparency).

The inner container 3 is a container to be inserted into the outer container 2, and contents such as beverages are poured to the inside. The inner container 3 has a tapered shape whose overall shape is substantially similar to that of the outer container 2, and has an opening 20a, a coupling portion 20b, a body portion 20, and a bottom portion 21 that closes a lower side of the body portion 20. A largest outer diameter D2 and a length L2 of the inner container 3 are set to slightly smaller dimensions relative to a largest inner diameter D1 and a length L1 of the outer container, respectively, in order to allow insertion into the outer container 2 (D1>D2 and L1>L2).

FIG. 3B is an enlarged view of an upper end portion of the inner container 3. The opening 20a having a diameter larger than that of the body portion 20 is formed on the upper end side of the inner container 3, and a stepped portion 22 having an annular shape having an enlarged diameter is formed at the opening 20a. In addition, the coupling portion 20b is formed on the lower side (between the opening 20a and the body portion 20) of the stepped portion 22, and an engagement protrusion 23 protruding to the outer peripheral side of the inner container 3 is formed on the coupling portion 20b. The stepped portion 22 and the engagement protrusion 23 are formed in parallel adjacent to each other in the axial direction of the inner container 3.

As illustrated in FIG. 4A to be described below, the engagement protrusion 23 engages with the engagement groove 13 formed on the inner circumference of the outer container 2, and has a function of locking and fixing the inner container 3 to the outer container 2. An axial cross-sectional shape of the engagement protrusion 23 is an arc shape corresponding to the curved surface of the engagement groove 13. The engagement protrusion 23 may extend along the circumferential direction of the inner container 3, or a plurality of engagement protrusions may be formed at intervals in the circumferential direction on the outer periphery of the inner container 3. The engagement protrusion 23 illustrated in FIG. 2B has, for example, an annular shape partially cut out in the circumferential direction. By providing a portion where the engagement protrusion 23 is not formed in the circumferential direction of the inner container 3, the engagement protrusion 23 is easily elastically deformed, and the engagement and the disengagement between the outer container 2 and the inner container 3 are facilitated.

As illustrated in FIGS. 2B and 3B, at the upper end of the stepped portion 22 (opening 20a) of the inner container 3, a flange portion 24 having an annular shape and projecting radially outward and continuous in the circumferential direction is formed. The radial width of the flange portion 24 is set to such a dimension that the flange portion 24 projects outward beyond the outer diameter of the outer container 2 when the inner container 3 is inserted into the outer container 2. The flange portion 24 constitutes the largest outer diameter portion of the inner container 3 and the double-walled container 1.

In addition, in the inner container 3, a spacer portion (gap forming portion) 25 having a protrusion shape protruding to the outer peripheral side is formed in the body portion 20 below the engagement protrusion 23. The spacer portion 25 abuts on the inner peripheral surface of the outer container 2 when the inner container 3 is inserted into the outer container 2, and has a function of forming a gap S between the outer container 2 and the inner container 3. The height (protrusion amount in the radial direction) of the spacer portion 25 is set equal to the dimension of the gap S between the outer container 2 and the inner container 3 at the body portion of the double-walled container 1. The spacer portion 25 keeps the gap S between the outer container 2 and the inner container 3 at a predetermined value, and prevents contact between the body portion 10 of the outer container 2 and the body portion 20 of the inner container 3. The gap S of the double-walled container 1 is preferably configured to be constant in the axial direction (vertical direction), but may be configured to gradually decrease or gradually increase in the axial direction. The width of the gap S in the radial direction is appropriately set between 3 mm and 6 mm, for example.

As illustrated in FIG. 2B, the spacer portion 25 is formed as, for example, an annular protrusion extending in the circumferential direction of the inner container 3. In the example of FIG. 2B, the spacer portion 25 is formed at least two positions above and below at an interval in the axial direction. The upper spacer portion 25 is formed in the vicinity of the engagement protrusion 23, and the lower spacer portion 25 is formed in the vicinity of the bottom portion of the body portion 20 of the inner container 3. The heights of the upper spacer portion 25 and the lower spacer portion 25 are preferably the same, but for example, either one may be formed higher or lower, such as the upper spacer portion 25 is higher than the lower spacer portion 25.

The bottom portion 21 of the inner container 3 is formed in a bottomed cylindrical shape having a diameter smaller than that of the tapered part of the body portion 20. As illustrated in FIG. 4B, a stepped surface (second stepped portion) 26 is formed between the tapered part of the body portion 20 and the bottom portion 21 inside the inner container 3. Here, in the inner container 3, an inner diameter D4 of the lower end of the tapered part facing the stepped surface 26 is, for example, a dimension corresponding to an outer diameter D3 of the bottom portion 11 of the outer container 2 in order to enable stacking of the double-walled container 1 as described below. In addition, an axial length L4 from the flange portion 24 to the stepped surface 26 of the inner container 3 corresponds to an axial length L3 from the lower end of the engagement groove 13 of the outer container 2 to the bottom portion 11 of the outer container 2, for example, in order to enable stacking of the double-walled container 1 as described below.

FIG. 4A is a partial cross-sectional view of the vicinity of an upper end of the double-walled container 1, and FIG. 4B is a partial cross-sectional view of the vicinity of a bottom portion of the double-walled container 1.

When the inner container 3 is inserted into the outer container 2, the spacer portion 25 of the inner container 3 comes into contact with the inner peripheral surface of the outer container 2 as illustrated in FIGS. 4A and 4B. As a result, the gap S corresponding to the height of the spacer portion 25 is held between the outer container 2 and the inner container 3, and a heat insulating space by air is formed between the outer container 2 and the inner container 3.

In addition, in a state where the inner container 3 is inserted into the outer container 2, as illustrated in FIG. 4A, the engagement protrusion 23 of the inner container 3 is engaged with the engagement groove 13 of the outer container 2, and the inner container 3 is fixed to the outer container 2. Note that, when discarding the double-walled container 1, the outer container 2 and the inner container 3 can be easily detached and separated by material by disengagement between the engagement groove 13 and the engagement protrusion 23.

In addition, in a state where the inner container 3 is inserted into the outer container 2, as illustrated in FIG. 4A, the lower surface of the flange portion 24 of the inner container 3 comes into contact with (or approaches) the upper end of the body portion 10 of the outer container 2, and the flange portion 24 of the inner container 3 projects radially outward beyond the outer container 2. As a result, at the upper end of the double-walled container 1, the gap S between the outer container 2 and the inner container 3 is closed by the flange portion 24 (or the gap S is minimized). Therefore, the outside air is prevented from entering the gap S between the outer container 2 and the inner container 3 by the flange portion 24, and the heat insulation performance of the double-walled container 1 is hardly deteriorated. In addition, when the content poured into the double-walled container 1 is drunk, the content can be prevented from flowing into the gap S between the outer container 2 and the inner container 3 by the flange portion 24.

Note that a predetermined gap (for example, 1 mm to 4 mm) may be provided without contact between the lower surface of the flange portion 24 of the inner container 3 and the upper end of the body portion 10 of the outer container 2, and an open portion (air ventilation portion) between the gap S of the double-walled container 1 and the outside air may be formed. In this case, for example, when the content is at a high temperature, the heat insulating layer (air) in the gap S is suppressed from being heated, so that deformation of the outer container 2 formed of PET or the like can be suppressed, and when the content is at a low temperature, the heat insulating layer (air) in the gap S is suppressed from being cooled, so that dew condensation occurring on the outer container 2 can be reduced.

The material of the inner container 3 is thermoplastic synthetic resin, and the specific material type is the same as that of the material of the outer container 2. The material of the inner container 3 may be the same as or different from the material of the outer container 2. Since contents such as beverages are poured into the inner container 3, it is preferable to apply PP, which is a material having high heat resistance, as an example.

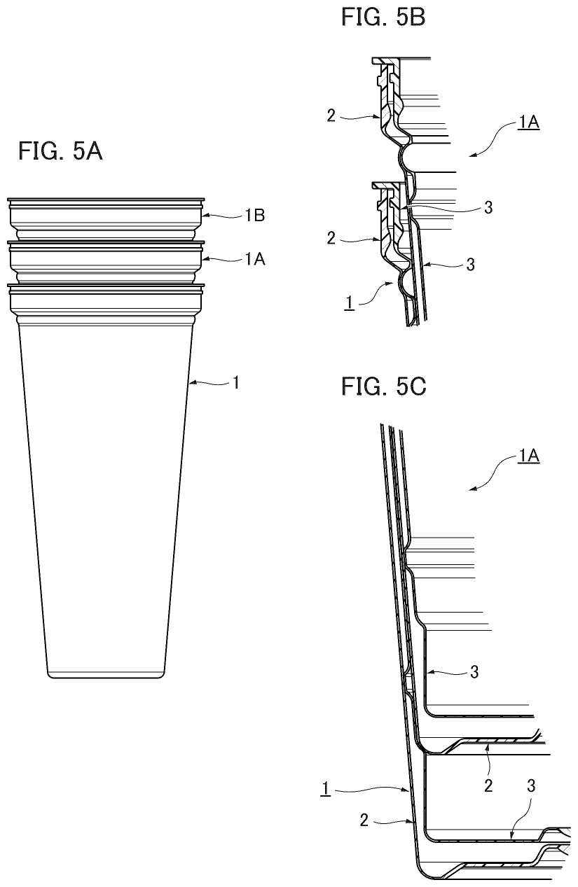

FIG. 5A is a front view illustrating a stacked state of double-walled containers 1, 1A, and 1B of the present embodiment. FIG. 5B is a partial cross-sectional view of the vicinity of upper ends of the double-walled containers 1 and 1A in the stacked state, and FIG. 5C is a partial cross-sectional view of the vicinity of bottom portions of the double-walled containers 1 and 1A in the stacked state.

Since the double-walled container 1 of the present embodiment has a tapered shape in which the upper side is opened and the diameter is reduced toward the bottom portion, the double-walled containers 1 can be stacked to overlap up and down. As described above, the inner diameter D4 of the lower end of the stepped surface 26 of the inner container 3 corresponds to the outer diameter D3 of the bottom portion 11 of the outer container 2. Therefore, at the time of stacking the double-walled container 1, the bottom surface of the upper double-walled container 1A comes into contact with the stepped surface 26 on the bottom portion side of the lower double-walled container 1. In addition, the inner container 3 of the lower double-walled container 1 and the outer container 2 of the upper double-walled container 1A come into surface contact with each other.

In addition, as described above, a dimension L4 from the flange portion 24 of the inner container 3 to the stepped surface 26 corresponds to a length L3 from the lower end of the engagement groove 13 of the outer container 2 to the bottom portion 11 of the outer container 2. Therefore, at the time of stacking the double-walled containers 1, the range from the lower end of the engagement groove 13 of the upper double-walled container 1A to the bottom portion 11 of the container is accommodated in the lower double-walled container 1, and as illustrated in FIGS. 5A and 5B, the range from the flange portion 24 of the upper double-walled container 1A to the engagement groove 13 is exposed to the outside. As a result, the height of the double-walled containers 1 in the stacked state can be made compact.

In addition, a distance is held between the inner container 3 of the double-walled container 1 of the present embodiment and the outer container 2 by the spacer portion 25, and the inner container 3 is hardly inclined in the axial direction with respect to the outer container 2 although there is a gap. Therefore, according to the present embodiment, the double-walled containers 1 stacked with the inner container 3 deflected in the axial direction is suppressed from wobbling in the axial direction, and the stability of the double-walled containers 1 at the time of stacking can be enhanced.

Next, a method for manufacturing the double-walled container of the present embodiment will be described. In the case of the sheet molding method, a sheet having a uniform thickness is clamped to a mold and vacuumed to be molded into a container shape. Therefore, at the time of molding the cup-shaped container having a deep bottom as in the present embodiment, the stretch rate of the sheet at the body portion is increased. Therefore, it is difficult to control the shape of the body portion, which is a highly stretched portion, and the wall thickness of the body portion, so that the physical properties (rigidity and top load) of the container are easily deteriorated. In addition, whitening of the container is likely to occur at the body portion, which is a highly stretched portion, and the appearance of the container is also likely to deteriorate. Moreover, it is also necessary to perform an operation of trimming the container from the sheet after molding the container.

On the other hand, the outer container 2 and the inner container 3 constituting the double-walled container 1 of the present embodiment are both molded by a biaxial stretch blow method.

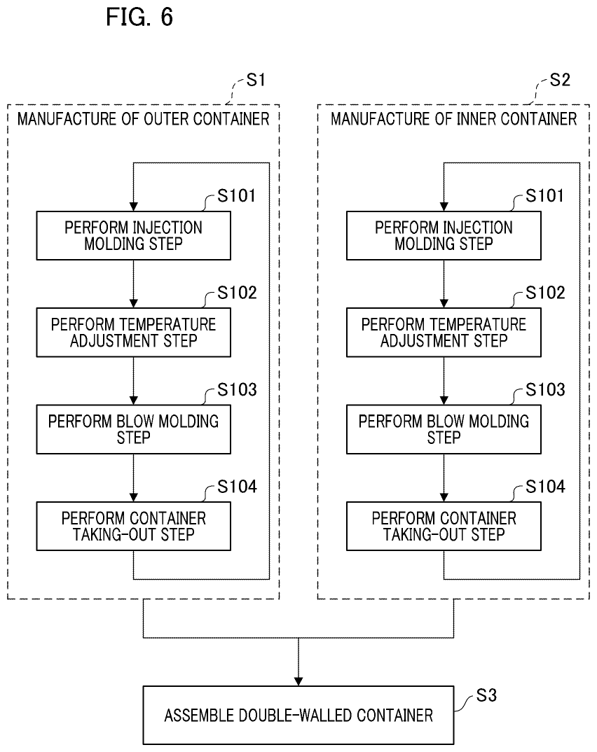

FIG. 6 is a view illustrating a manufacturing step of the double-walled container of the present embodiment. In the present embodiment, the outer container 2 and the inner container 3 are manufactured from a resin preform by the biaxial stretch blow method (S1 and S2). For example, the overall shape of the preform is a bottomed cylindrical shape in which one end side is opened and the other end side is closed. Thereafter, the inner container 3 is inserted from the upper surface side of the manufactured outer container 2 to assemble the double-walled container 1 (S3). Note that the outer container 2 and the inner container 3 may be manufactured in parallel using two blow molding apparatuses, or may be manufactured by replacing the mold of one blow molding apparatus.

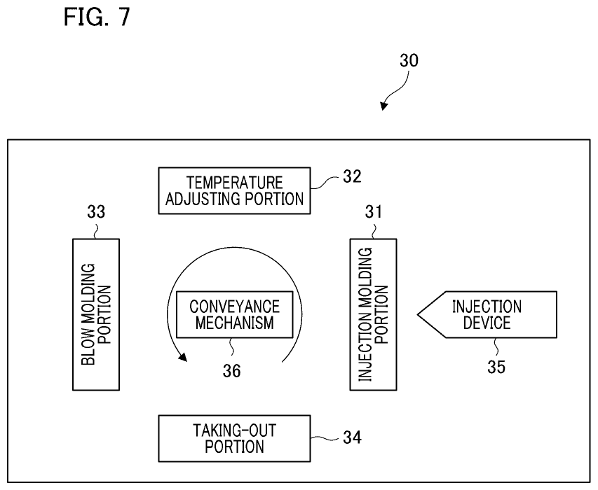

FIG. 7 is a view illustrating a configuration example of a blow molding apparatus 30 applied to the manufacture of the container of the present embodiment. The blow molding apparatus 30 illustrated in FIG. 7 is a hot parison type (also referred to as a one-stage type) apparatus that blow-molds a container by utilizing residual heat (internal heat quantity) from injection molding without cooling the preform to room temperature. Note that the blow molding apparatus 30 manufactures either the outer container 2 or the inner container 3 in one container molding cycle.

The blow molding apparatus 30 includes an injection molding portion 31, a temperature adjusting portion 32, a blow molding portion 33, a taking-out portion 34, and a conveyance mechanism 36. The injection molding portion 31, the temperature adjusting portion 32, the blow molding portion 33, and the taking-out portion 34 are disposed at positions rotated a predetermined angle (for example, 90 degrees) about the conveyance mechanism 36.

The conveyance mechanism 36 includes a transfer plate (not illustrated) that moves to rotate about an axis in a direction perpendicular to the plane of paper of FIG. 7. On the transfer plate, one or more neck molds (not illustrated) for holding a neck portion formed at an opening-side end portion of the preform or the container (the outer container 2 or the inner container 3) are disposed at each predetermined angle. The conveyance mechanism 36 conveys the preform (or the container) having the neck portion held by the neck mold in the order of the injection molding portion 31, the temperature adjusting portion 32, the blow molding portion 33, and the taking-out portion 34 by rotating the transfer plate 90 degrees. Note that the conveyance mechanism 36 further includes a lifting and lowering mechanism (vertical mold opening/closing mechanism) and a mold opening mechanism of the neck mold, and also performs an operation of lifting and lowering the transfer plate and an operation related to mold closing and mold opening (demolding) in the injection molding portion 31 or the like.

The injection molding portion 31 includes an injection cavity mold and an injection core mold, which are not illustrated, and manufactures a preform. An injection device 35 that supplies a resin material, which is a raw material of the preform, is connected to the injection molding portion 31.

In the injection molding portion 31, the injection cavity mold, the injection core mold, and the neck mold of the conveyance mechanism 36 described above are closed to form a mold space having a preform shape. Then, by pouring the resin material from the injection device 35 into such a mold space having a preform shape, the preform is manufactured by the injection molding portion 31.

Note that even when the molds of injection molding portion 31 are opened, the neck mold of the conveyance mechanism 36 is not released, and the preform is held and conveyed as it is. The number of preforms simultaneously molded by the injection molding portion 31 (that is, the number of containers that can be simultaneously molded by the blow molding apparatus) can be appropriately set.

The temperature adjusting portion 32 performs temperature equalization and uneven temperature removal on the preform manufactured by the injection molding portion 31 to adjust the temperature of the preform to a temperature suitable for blow molding (for example, about 90° C. to 105° C.) and a temperature distribution suitable for a container shape to be formed. In addition, the temperature adjusting portion 32 also has a function of cooling the preform in a high temperature state after injection molding.

The temperature adjusting portion 32 includes, for example, a cavity mold (temperature adjustment pot mold, heating pot mold) capable of accommodating the preform and a temperature adjustment rod which is a mold member inserted inside the preform (both are not illustrated), and heats the preform in a non-contact manner. Alternatively, the temperature adjusting portion 32 may have a configuration in which a cooling core for blowing compressed air into the preform and a cavity mold are combined. In this case, the temperature adjusting portion 32 blows compressed air into the preform, so that the preform can be cooled by cooling by the compressed air and heat exchange through contact with the cavity mold.

The blow molding portion 33 performs biaxial stretch blow molding on the preform the temperature of which has been adjusted by the temperature adjusting portion 32 to manufacture a container. The blow molding portion 33 includes a blow cavity mold that is a pair of split molds corresponding to the shape of the container, a bottom mold, a stretching rod, and an air introduction member (blow core mold; all of which are not illustrated). The blow molding portion 33 performs blow molding while stretching the preform. As a result, the preform can be shaped into the shape of the blow cavity mold to manufacture a container.

The taking-out portion 34 is configured to release the neck portion of the container manufactured by the blow molding portion 33 from the neck mold and take out the container to the outside of the blow molding apparatus 30.

Next, the container molding cycle of the blow molding apparatus 30 will be described. The container molding cycle includes an injection molding step (S101), a temperature adjustment step (S102), a blow molding step (S103), and a container taking-out step (S104). Note that since the container molding cycle (S1) of the outer container 2 and the container molding cycle (S2) of the inner container 3 are similar to each other, redundant description is omitted.

In the injection molding step (S101), in the injection molding portion 31, resin is injected from the injection device 35 into the mold space having a preform shape formed by the injection cavity mold, the injection core mold, and the neck mold of the conveyance mechanism 36 to manufacture the preform.

When the injection molding of the preform is completed, the molds of injection molding portion 31 are opened, and the preform is demolded from the injection cavity mold and the injection core mold. Next, the transfer plate of the conveyance mechanism 36 moves so as to rotate a predetermined angle, and the preform held by the neck mold is conveyed to the temperature adjusting portion 32.

Subsequently, as the temperature adjustment step (S102), in the temperature adjusting portion 32, temperature adjustment for bringing the temperature of the preform close to a temperature suitable for final blowing is performed.

In the temperature adjustment step (S102), the preform held in the neck mold is accommodated in the cavity mold by lowering the transfer plate. In addition, when the temperature adjustment rod lowers, the temperature adjustment rod is inserted into the preform.

In the temperature adjusting portion 32, the preform is heated by the cavity mold and the temperature adjustment rod. As a result, the temperature of the preform is adjusted so as not to be equal to or lower than a temperature suitable for blow molding, and the uneven temperature occurred from injection molding is also reduced. Note that, in the temperature adjustment step, a cooling core for ejecting the compressed air may be inserted instead of the temperature adjustment rod, and the temperature adjustment may be performed by blowing the compressed air (flowing the compressed air) into the preform.

After the temperature adjustment step, the transfer plate of the conveyance mechanism 36 moves so as to rotate a predetermined angle, and the preform that is held by the neck mold and the temperature of which has been adjusted is conveyed to the blow molding portion 33.

Subsequently, in the blow molding step (S103), the blow molding of the container is performed in the blow molding portion 33.

First, the blow cavity mold is closed, the preform is accommodated in the mold space, and the air introduction member (blow core) is lowered, so that the air introduction member abuts on the neck portion of the preform. Then, the stretching rod (longitudinal stretching member) is lowered to hold the bottom portion of the preform from the inner surface, longitudinal stretching is performed, and the blowing air is supplied from the air introduction member to perform lateral stretching of the preform (biaxial stretch blow method). As a result, the preform is inflated and shaped so as to be in close contact with the mold space of the blow cavity mold, and is blow-molded into the container. Note that the bottom mold is caused to stand by at a lower position at which the bottom mold does not contact the bottom portion of the preform before mold closing of the blow cavity mold, and is quickly raised to the molding position before closing the mold or after closing the mold.

As described above, in the biaxial stretch blow method, the preform made of plasticized resin is longitudinally stretched by the stretching rod in a blow mold, and the preform is laterally stretched by the blowing air introduced into the preform to manufacture a container shaped into the shape of the blow mold.

In the biaxial stretch blow method, by applying a preform having a shape corresponding to the container, the wall thickness distribution of the container can be adjusted including the wall thickness of the body portion, which is a highly stretched portion. As a result, it is easy to bring the wall thickness of the container to be shaped close to a constant value. In addition, by applying a preform having a shape corresponding to the container, excessive stretching of the material does not occur in the body portion of the highly stretched portion, so that whitening of the container hardly occurs.

In addition, in the biaxial stretch blow method, since the preform is blow-molded by air while being longitudinally stretched by the stretching rod according to the depth of the container, the shape of the container is stabilized as compared with that made by the sheet molding method, and the accuracy of the shape (formability) can be enhanced. For example, in the biaxial stretch blow method, the cross-sectional shape of the container can be substantially a perfect circle. In addition, in the case of forming the spacer portion 25 that abuts on another container to hold a gap between the containers and the engagement structure between the containers such as the engagement groove 13 and the engagement protrusion 23, a high level of dimensional accuracy is required for both the outer container 2 and the inner container 3, but the biaxial stretch blow method can satisfy such a dimensional accuracy requirement.

In addition, in the biaxial stretch blow method, the preform disposed in the blow mold including a pair of openable and closable split molds is blow-molded and shaped into a container. Therefore, the present embodiment is also advantageous in that an undercut structure that is difficult to mold in the case of a mold that is not a split mold applied in the sheet molding method, such as the spacer portion 25 of the inner container 3, can also be formed in the container.

In addition, in the biaxial stretch blow method, since the preform having a shape corresponding to the container is injection-molded, it is not necessary to perform an operation of trimming the container from the sheet as in the sheet molding method, and waste material due to trimming does not occur. Further, in the biaxial stretch blow method, a container having whitening, a shape defect, or the like is less likely to occur as compared with the sheet molding method, and thus the yield at the time of container manufacturing is high. Accordingly, by the biaxial stretch blow method, the manufacturing cost of the container can be suppressed as compared with the sheet molding method.

Note that, in the biaxial stretch blow method, a container is manufactured using a preform, and thus a gate mark of the preform remains at the bottom portion of the container manufactured by the biaxial stretch blow method. In addition, a parting line of the neck mold or blow mold including a pair of split molds remains in the body portion or an opening (stepped portion) of the container. Therefore, the outer container 2 and the inner container 3 manufactured by the biaxial stretch blow method can be easily identified by confirming the gate mark of the container bottom portion and the parting line of the container body portion.

When the blow molding ends, the blow cavity mold and the bottom mold are opened. As a result, the container becomes movable from the blow molding portion 33.

Subsequently, as the container taking-out step (S104), the transfer plate of the conveyance mechanism 36 moves to rotate a predetermined angle, and the container is conveyed to the taking-out portion 34. In the taking-out portion 34, the neck portion of the container is released from the neck mold, and the container is taken out to the outside of the blow molding apparatus 30.

Thus, the series of steps of the container molding cycle ends. Thereafter, by moving the transfer plate of the conveyance mechanism 36 to rotate a predetermined angle, the steps of S101 to S104 described above are repeated. During the operation of the blow molding apparatus 30, the manufacture of four sets of containers having a time difference of one step is executed in parallel.

Note that either an injection stretch blow molding method (ISBM) or a stretch blow molding method (SBM) may be applied to manufacture the outer container 2 and the inner container 3 of the present embodiment. In the injection stretch blow method, injection molding and blow molding of a preform are executed in a series of processes, and the preform having residual heat from the injection molding is biaxially stretch-blown. In addition, in the stretch blow molding method, a preform prepared in advance is heated to be plasticized, and is then biaxially stretch-blown. Since these methods are known per se, the detailed description thereof is omitted.

The present invention is not limited to the above-described embodiment, and various improvements and design changes may be made without departing from the gist of the present invention.

The relationship between the engagement protrusion 23 and the engagement groove 13 of the double-walled container 1 is not limited to the configuration of the above embodiment. For example, an engagement protrusion protruding to the inner circumferential side may be formed on the outer container 2, and an engagement groove may be formed on the outer periphery of the inner container 3.

The spacer portion 25 of the double-walled container 1 may be formed on the inner circumferential side of the outer container 2. In addition, the shape and arrangement of the spacer portion 25 are not limited to those of the above embodiment. For example, the spacer portion 25 may have a plurality of protrusions extending in the axial direction (or in an oblique direction with respect to the axial direction) disposed at intervals in the circumferential direction of the container.

Additionally, the embodiment disclosed herein is to be considered in all respects as illustrative and not restrictive. The scope of the present invention is indicated not by the above-described description but by the claims, and it is intended that meanings equivalent to the claims and all modifications within the scope are included.

1. A double-walled resin container comprising:
an outer container made of resin and having a tapered shape in which an upper surface is opened, a bottom surface is closed, and a diameter is reduced from an upper surface side to a bottom surface side; and
an inner container made of resin and inserted into the outer container from the upper surface side,
the double-walled resin container including a heat insulating space in a gap between the outer container and the inner container, wherein
the outer container and the inner container are each molded by a biaxial stretch blow method.

2. The double-walled resin container according to claim 1, wherein
one of the outer container and the inner container has an engagement protrusion extending in a circumferential direction, and
an other of the outer container and the inner container has an engagement groove extending in the circumferential direction and engaging with the engagement protrusion.

3. The double-walled resin container according to claim 1, wherein
at least one of the outer container and the inner container includes a spacer portion that protrudes toward an other container and holds the heat insulating space.

4. The double-walled resin container according to claim 1, wherein
the inner container includes, at an upper end, a flange portion having an annular shape and projecting radially outward, and
an upper end of the outer container contacts a lower surface of the flange portion.

5. A method for manufacturing a double-walled resin container that is formed by overlapping an outer container and an inner container, which are both made of resin, and includes a heat insulating space in a gap between the outer container and the inner container, the method comprising:
molding, by a biaxial stretch blow method, the outer container that has a tapered shape in which an upper surface is opened, a bottom surface is closed, and a diameter is reduced from an upper surface side to a bottom surface side, from a preform made of resin;
molding the inner container from a preform made of resin by the biaxial stretch blow method; and
inserting the inner container from the upper surface side of the outer container to assemble the double-walled resin container.
